(19) United States
(12) Patent Application Publication
(10) Pub. No.: US 2023/0113669 A1
(43) Pub. Date: Apr. 13, 2023

(54) Lidar Sensor with a Redundant Beam Scan

(71) Applicant: LUMINAR, LLC, Orlando, FL (US)

(72) Inventors: Stephen L. Mielke, Orlando, FL (US); Philip W. Smith, Orlando, FL (US); Roger S. Cannon, Orlando, FL (US); Jason P. Wojack, Orlando, FL (US); Jason M. Eichenholz, Orlando, FL (US); Scott R. Campbell, Orlando, FL (US)

(21) Appl. No.: 17/954,914

(22) Filed: Sep. 28, 2022

Related U.S. Application Data
(60) Provisional application No. 63/250,726, filed on Sep. 30, 2021.

(51) Int. Cl. G01S 7/481; G01S 17/89; G01S 17/931

(52) U.S. Cl. CPC G01S 7/4817; G01S 17/89; G01S 17/931; G01S 2007/4975

(57) ABSTRACT

Scanning lidar systems and methods for performing a redundant beam scan to reduce data loss resulting from obscurants are presented. An example system comprises a first light source and a second light source having a spatial displacement relative to the first light source. The example system also includes a mirror assembly and an optical window configured to transmit the light pulses emitted from the light sources, wherein the spatial displacement of the second light source relative to the first light source is such that the first and second light pulses produce two pixels corresponding to a same portion of an image. The example system also includes a receiver configured to receive the light pulses when scattered by one or more targets, the receiver including two or more detectors configured to detect at least one of the light pulses and output an electric signal for generating the two pixels.

### CROSS-REFERENCE TO RELATED APPLICATIONS

This application claims the benefit of U.S. Provisional Application No. 63/250,726, filed Sep. 30, 2021, and entitled “LIDAR SENSOR WITH A REDUNDANT BEAM SCAN”, which is incorporated herein by reference in its entirety.

### FIELD OF THE DISCLOSURE

The present disclosure generally relates to object detection capabilities of autonomous vehicle systems and, more particularly, to redundant beam scanning technologies that reduce data loss resulting from obscurants expected to contact an optical window of a lidar system for an autonomous vehicle.

### BACKGROUND

Generally speaking, autonomous vehicle systems need to control vehicle operations such that the vehicle effectively and safely drives on active roadways. Accordingly, the autonomous system must recognize upcoming environments in order to determine and execute appropriate actions in response. Lidar systems are typically included as part of the environmental recognition systems, and at a high level, obtain information through emitting and receiving collimated laser light. However, these emissions suffer from environmental obscurants that interfere and/or block the optical path of the light.

Particularly, obscurants that adhere to the optical window of the lidar system can block a significant portion of the optical path of the light, resulting in data loss corresponding to substantial portions of the external vehicle environment. In extreme cases, the data loss may cause the autonomous systems to overlook or otherwise not identify obstacles or other objects in the vehicle’s path. As a result, the autonomous vehicle may unintentionally perform hazardous driving actions that put, at a minimum, the vehicle occupants at risk.

Accordingly, a need exists for systems that are resilient to these environmental obscurants, and particularly for systems that can effectively recognize entire upcoming vehicle environments despite the presence of an optical window obscurant.

### SUMMARY

The scanning lidar systems of the present disclosure may eliminate/minimize data loss from optical window and environmental obscurants by providing multiple offset lasers that perform a redundant beam scan. Namely, the scanning lidar systems of the present disclosure include a first light source and a second light source that is spatially displaced relative to the first light source. This spatial displacement of the second light source relative to the first light source is greater than an average diameter of environmental obscurants that the scanning lidar system generally encounters when scanning the external vehicle environment. More specifically, the spatial displacement is greater than the average diameter of obscurants that may physically contact (i.e., attach to) the optical window, through which the light pulses are transmitted/received to/from the external vehicle environment. In this manner, the scanning lidar systems of the present disclosure may effectively scan an external vehicle environment without the data loss conventional systems encounter due to environmental obscurants, and particularly obscurants contacting the optical window.

In one embodiment, a scanning lidar system for performing a redundant beam scan to reduce data loss resulting from obscurants comprises: a first light source configured to emit a first light beam comprising a first light pulse; a second light source configured to emit a second light beam comprising a first light pulse and having a spatial displacement relative to the first light source; a mirror assembly configured to adjust an azimuth emission angle and an elevation emission angle of the first light pulse and the second light pulse; an optical window configured to transmit the first light pulse and the second light pulse, wherein the spatial displacement of the second light source relative to the first light source is such that the first light pulse and the second light pulse produce two pixels corresponding to a same portion of an image, wherein the two pixels are used to render the same portion of the image; and a receiver configured to receive the first light pulse and the second light pulse that are scattered by one or more targets, the receiver including two or more detectors configured to detect the first light pulse or the second light pulse and output an electric signal for generating the two pixels.

### BRIEF DESCRIPTION OF THE DRAWINGS

FIG. 1 illustrates a block diagram of an example lidar system in which the redundant beam scan of this disclosure can be implemented.

FIG. 2A illustrates example zones of interest projected onto the optical window, including an obscurant blocking a portion of a zone of interest, through which the redundant beam scan of the lidar system of FIG. 1 may pass.

FIG. 2B illustrates the data loss effects of the optical window obscurant of FIG. 2A on prior art lidar systems.

FIG. 2C illustrates the data resiliency of the redundant beam scan of the lidar system of FIG. 1 when encountering the optical window obscurant of FIG. 2A.

FIG. 3 illustrates an example scan pattern which the lidar system of FIG. 1 can produce when identifying targets within a field of regard.

FIG. 4A illustrates an example vehicle in which the lidar system of FIG. 1 can operate.

FIG. 4B illustrates another example vehicle in which the lidar system of FIG. 1 can operate.

FIG. 5A illustrates an example environment in the direction of travel of an autonomous vehicle.

FIG. 5B illustrates an example pixel readout over a field of regard for the lidar system of FIG. 1 when the optical window is free of obscurants.

FIG. 5C illustrates an example pixel readout over a field of regard for the lidar system of FIG. 1 when an obscurant is present on the optical window.

FIG. 6 illustrates a distribution of obscurant sizes at several vehicle travel speeds compared to the beam diameter and physical separation of each laser included in the redundant beam scan of the lidar system of FIG. 1.

FIG. 7 is a flow diagram of a method for configuring a scanning lidar system to perform a redundant beam scan to reduce data loss resulting from obscurants.

### DETAILED DESCRIPTION

Techniques of this disclosure are used to perform a redundant beam scan, such that data loss resulting from obscurants expected to contact an optical window of a lidar system for an autonomous vehicle may be reduced/eliminated. The vehicle may be a fully self-driving or “autonomous” vehicle, a vehicle controlled by a human driver, or some hybrid of the two. For example, the disclosed techniques may be used to capture more complete vehicle environment information than was conventionally possible to improve the safety/performance of an autonomous vehicle, to generate alerts for a human driver, or simply to collect data relating to a particular driving trip. The sensors described herein are part of a lidar system, but it should be understood that the techniques of the present disclosure may be applicable to any type or types of sensors capable of sensing an environment through which the vehicle is moving, such as radar, cameras, and/or other types of sensors that may experience data loss resulting from obscurants. Moreover, the vehicle may also include other sensors, such as inertial measurement units (IMUs), and/or include other types of devices that provide information on the current position of the vehicle (e.g., a GPS unit).

### Redundant Beam Scanning Overview

As mentioned, the systems and methods of the present disclosure may provide redundant beam scanning for autonomous vehicles in a manner that reduces/eliminates data loss resulting from obscurants. More specifically, systems of the present disclosure may include two light sources spatially displaced relative to one another at greater than an average diameter of obscurants expected to contact an optical window through which light pulses from the two light sources are emitted. Light pulses emitted from the two light sources may pass through the optical window maintaining the spatial displacement of the two light sources, and as a result, may generally avoid simultaneous signal disruption/blockage by the obscurant. A mirror assembly may adjust the azimuthal and elevation emission angles of light pulses emitted by the two light sources in a scanning pattern that defines the field of regard for the lidar system. In this manner, the systems of the present disclosure may effectively and reliably receive lidar data for the entire field of regard because at least one of the two emitted light pulses corresponding to a point in the field of regard may return to the lidar system for pixel generation regardless of whether or not an obscurant is contacting the optical window. These techniques are described in greater detail below.

As an example of the scanning lidar systems of the present disclosure, assume that an environmental obscurant (e.g., a rain droplet, a dirt particle, etc.) attaches to the optical window during operation of an autonomous vehicle, and more specifically, during scanning of the scanning lidar systems of the present disclosure. Further, assume that the environmental obscurant has a diameter of approximately 1 millimeter (mm), light pulses emitted from each light source (first and second light sources) have a beam diameter of approximately 2 mm, and the spatial separation of the two light sources is approximately 7 mm. In this example, as the optical paths of the light pulses from the two light sources are adjusted by the azimuth and elevation mirrors, one or more light pulses from at most one light source may be partially blocked (e.g., 1 mm obscurant may block up to half of the 2 mm diameter light pulse) by the obscurant at any particular combination of azimuth and elevation emission angles. However, at these particular combinations of azimuth and elevation emission angles, the light pulses from the unblocked light source are transmitted through the optical window without interference from the obscurant because the unblocked light source light pulses are 7 mm away from the obscurant. As a result, the unblocked light source obtains data corresponding to the external vehicle environment that the partially blocked light source is unable to obtain due to the presence of the obscurant.

As referenced herein, the unblocked light source may obtain data (e.g., pixel data) corresponding to a same portion of an image that the partially/completely blocked light source is unable to obtain due to the presence of the obscurant. It should therefore be understood that references to “same pixel data”, “same data”, and pixels generated from two different light sources being the “same” may represent pixel data corresponding to a same portion of an image, and not strictly identical pixels within the image. For example, references to “same pixel data”, “same data”, and pixels generated from two different light sources being the “same” may represent pixel data associated with two pixels that are adjacent to one another, within several pixels of one another, and/or identical, such that the pixel data of the two pixels corresponds to a same portion of the resulting image.

### Example Techniques for Redundant Beam Scanning to Reduce Data Loss Resulting From Obscurants

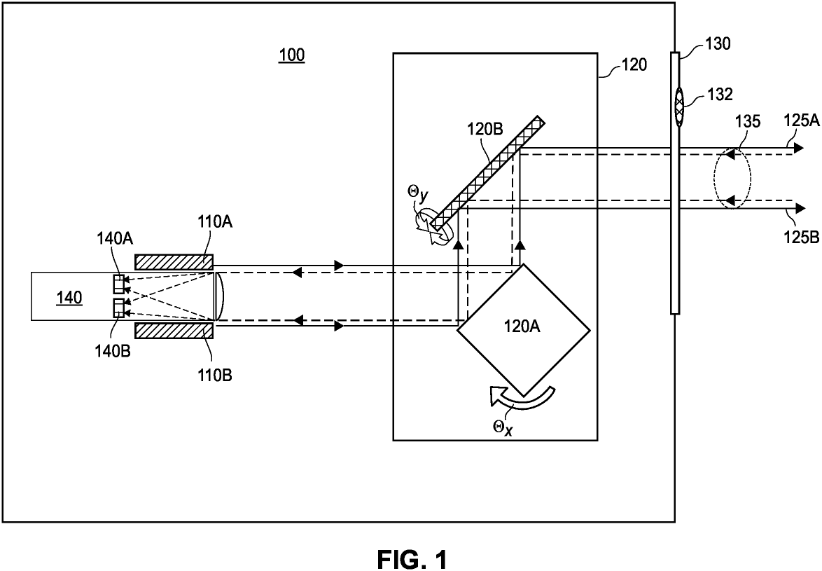

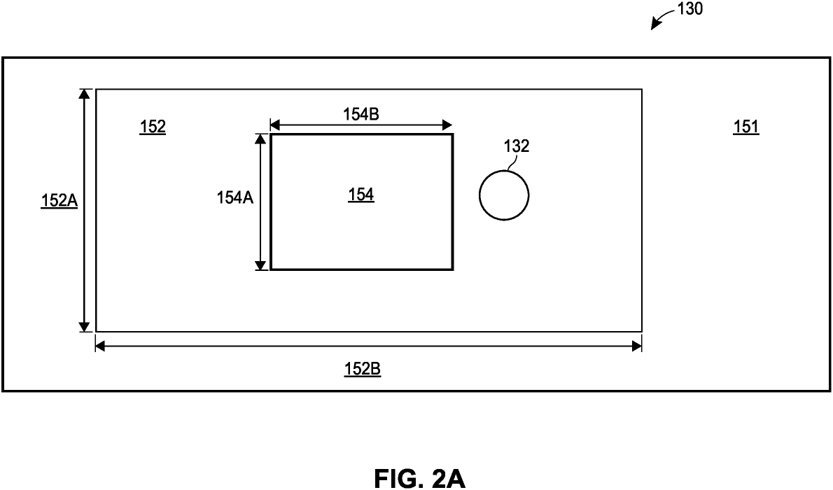

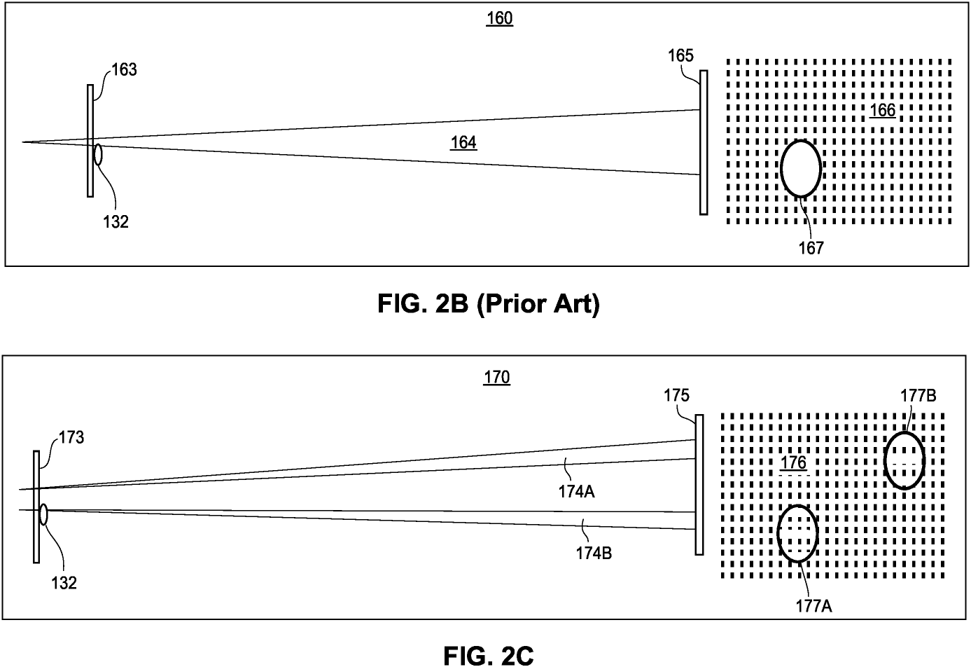

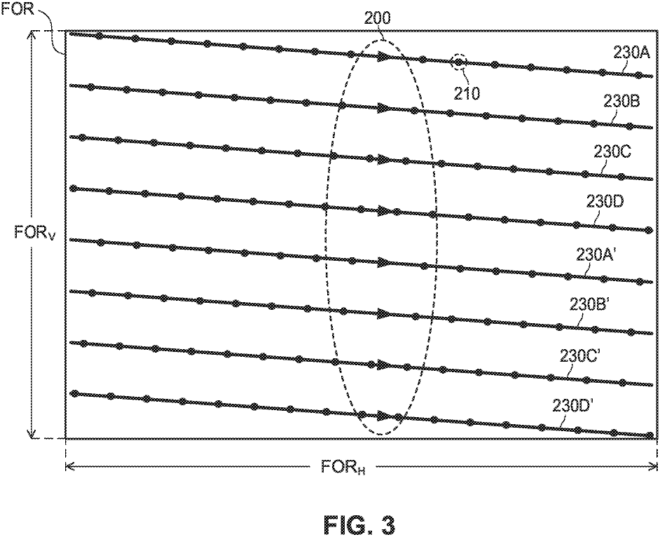

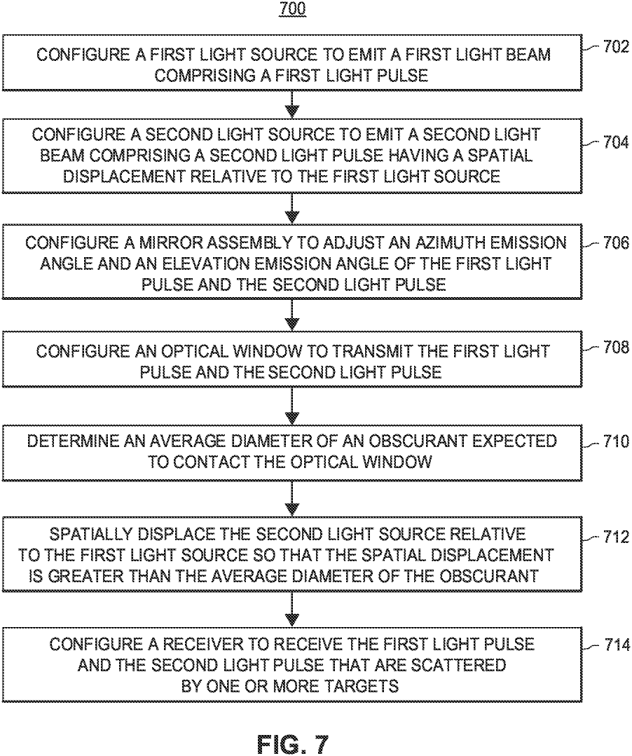

In the discussion below, example systems and methods for configuring a redundant beam scan to reduce data loss resulting from obscurants will first be described, with reference to FIG. 1. FIGS. 2A-2C illustrate the differences between conventional lidar systems and the improved lidar systems of the present disclosure when an obscurant is in contact with the optical window. Because the example architectures and techniques discussed herein utilize lidar sensors, example lidar systems are then discussed with reference to FIGS. 3-5C. FIG. 6 illustrates a distribution of obscurant diameters at various speeds of a vehicle used to inform the spatial displacement of light sources in the lidar systems of the present disclosure. Finally, example methods relating to configuring a system to perform, performing, and/or otherwise manufacturing a system capable of performing a redundant beam scan to reduce data loss resulting from obscurants are discussed with respect to the flow diagram of FIG. 7.

FIG. 1 illustrates a block diagram of an example lidar system 100 configured to reduce data loss resulting from obscurants while performing a redundant beam scan. The example lidar system 100 is generally utilized by an autonomous vehicle (e.g., to make intelligent driving decisions based on the vehicle’s current environment), or by a non-autonomous vehicle for other purposes (e.g., to collect data pertaining to a particular driving trip). For example, the data obtained by the example lidar system 100 may be input to a vehicle control component (not shown), which processes the data to generate vehicle control signals that control one or more operations of the vehicle, such as adjusting the orientation of the front tires of the vehicle, applying the brakes, or the like.

As the term is used herein, an “autonomous” or “self-driving” vehicle is a vehicle configured to sense its environment and navigate or drive with no human input, with little human input, with optional human input, and/or with circumstance-specific human input. For example, an autonomous vehicle may be configured to drive to any suitable location and control or perform all safety-critical functions (e.g., driving, steering, braking, parking) for the entire trip, with the driver not being expected (or even able) to control the vehicle at any time. As another example, an autonomous vehicle may allow a driver to safely turn his or her attention away from driving tasks in particular environments (e.g., on freeways) and/or in particular driving modes.

An autonomous vehicle may be configured to drive with a human driver present in the vehicle, or configured to drive with no human driver present. As an example, an autonomous vehicle may include a driver’s seat with associated controls (e.g., steering wheel, accelerator pedal, and brake pedal), and the vehicle may be configured to drive with no one seated in the driver’s seat or with limited, conditional, or no input from a person seated in the driver’s seat. As another example, an autonomous vehicle may not include any driver’s seat or associated driver’s controls, with the vehicle performing substantially all driving functions (e.g., driving, steering, braking, parking, and navigating) at all times without human input (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

As the term is used herein, a “vehicle” may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), or spacecraft. In particular embodiments, a vehicle may include an internal combustion engine or an electric motor that provides propulsion for the vehicle.

Generally, the example lidar system 100 may be used to determine the distance to one or more downrange objects. By scanning the example lidar system 100 across a field of regard, the system 100 can be used to map the distance to a number of points within the field of regard. Each of these depth-mapped points may be referred to as a pixel or a voxel. A collection of pixels captured in succession (which may be referred to as a depth map, a point cloud, or a point cloud frame) may be rendered as an image or may be analyzed to identify or detect objects or to determine a shape or distance of objects within the field of regard. For example, a depth map may cover a field of regard that extends 60° horizontally and 15° vertically, and the depth map may include a frame of 100-2000 pixels in the horizontal direction by 4-400 pixels in the vertical direction.

The example lidar system 100 may be configured to repeatedly capture or generate point clouds of a field of regard at any suitable frame rate between approximately 0.1 frames per second (FPS) and approximately 1,000 FPS, for example. The point cloud frame rate may be substantially fixed or dynamically adjustable, depending on the implementation. In general, the example lidar system 100 can use a slower frame rate (e.g., 1 Hz) to capture one or more high-resolution point clouds, and use a faster frame rate (e.g., 10 Hz) to rapidly capture multiple lower-resolution point clouds.

The field of regard of the example lidar system 100 can overlap, encompass, or enclose at least a portion of an object, which may include all or part of an object that is moving or stationary relative to example lidar system 100. For example, an object may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more distinct objects.

As illustrated in FIG. 1, the example lidar system 100 includes two light sources 110A, 110B (which may be referenced herein as a first light source 110A and a second light source 110B), that are spatially displaced relative to one another. The light sources 110A, 110B may be, for example, a laser (e.g., a laser diode) that emits light having a particular operating wavelength in the infrared, visible, or ultraviolet portions of the electromagnetic spectrum. In operation, the light sources 110A, 110B are configured to emit respective light pulses 125A, 125B (which may be referenced herein as a first light beam/pulse 125A and a second light beam/pulse 125B or the light beams/pulses 125A, 125B), and which may be continuous-wave, pulsed, or modulated in any suitable manner for a given application. In certain aspects, the first light source 110A has an angular displacement relative to the second light source 110B in an orthogonal direction relative to the spatial displacement of the first light source 110A from the second light source 110B. In some aspects, the first light pulse 125A and the second light pulse 125B have approximately identical wavelengths.

Moreover, as illustrated in FIG. 1, the two light sources 110A, 110B are two separate light sources, such that each light source 110A, 110B includes a laser diode followed by a semiconductor optical amplifier that emits an output beam. However, in certain embodiments, a single light source (e.g., laser diode + fiber-optic amplifier) that is split into two outputs may comprise the two light sources 110A, 110B. For example, a fiber-optic splitter may split the output from the fiber-optic amplifier into two optical fibers, and each optical fiber may be terminated by a lens or collimator that produces an output beam. In this example, the two lenses/collimators may be spatially displaced to produce the spatially displaced output beams of the two light sources 110A, 110B.

The output beams 125A, 125B may be directed downrange by a mirror assembly 120 across a field of regard for the example lidar system 100 based on the angular orientation of a first mirror 120A and a second mirror 120B. A “field of regard” of the example lidar system 100 may refer to an area, region, or angular range over which the example lidar system 100 may be configured to scan or capture distance information. When the example lidar system 100 scans the output beams 125A, 125B within a 30-degree scanning range, for example, the example lidar system 100 may be referred to as having a 30-degree angular field of regard. The mirror assembly 120 may be configured to scan the output beams 125A, 125B horizontally and vertically, and the field of regard of the example lidar system 100 may have a particular angular width along the horizontal direction and another particular angular width along the vertical direction. For example, the example lidar system 100 may have a horizontal field of regard of 10° to 120° and a vertical field of regard of 2° to 30°.

In particular, the mirror assembly 120 includes at least the first mirror 120A and the second mirror 120B configured to adjust the azimuth emission angle and elevation emission angle of the light pulses emitted from the two light sources 110A, 110B. Generally speaking, the mirror assembly 120 steers the output beams 125A, 125B in one or more directions downrange using one or more actuators driving the first mirror 120A and the second mirror 120B to rotate, tilt, pivot, or move in an angular manner about one or more axes, for example. While FIG. 1 depicts only two mirrors 120A, 120B, the example lidar system 100 may include any suitable number of flat or curved mirrors (e.g., concave, convex, or parabolic mirrors) to steer or focus the output beams 125A, 125B or the input beams 135. In certain aspects, the mirror assembly 120 additionally comprises an intermediate mirror configured to reflect the first light pulse 125A and the second light pulse 125B from the azimuth mirror 120A to the elevation mirror 120B. In these aspects, the intermediate mirror may be a fixed mirror (e.g., non-rotating, non-moving), such as a folding mirror.

The first mirror 120A and the second mirror 120B may be communicatively coupled to a controller (not shown), which may control the mirrors 120A, 120B so as to guide the output beams 125A, 125B in a desired direction downrange or along a desired scan pattern. In general, a scan (or scan line) pattern may refer to a pattern or path along which the output beams 125A, 125B is directed. The example lidar system 100 can use the scan pattern to generate a point cloud with points or “pixels” that substantially cover the field of regard. The pixels may be approximately evenly distributed across the field of regard, or distributed according to a particular non-uniform distribution.

The first mirror 120A is configured to adjust the azimuth emission angle of the emitted light pulses 125A, 125B, and the second mirror 120B is configured to adjust the elevation emission angle of the emitted light pulses 125A, 125B. In certain aspects, the first mirror 120A configured to adjust the azimuth emission angle is a polygonal mirror configured to rotate along an orthogonal axis (e.g., by an angle θₓ) relative to the propagation axis of the light pulses 125A, 125B. For example, the first mirror 120A may rotate by approximately 35° along an orthogonal axis relative to the propagation axis of the light pulses 125A, 125B. In certain aspects, the rotation axis of the first mirror 120A may not be orthogonal to the propagation axis of the light pulses 125A, 125B. For example, the first mirror 120A may be a folding mirror with a rotation axis that is approximately parallel to the propagation axis of the light pulses 125A, 125B. In this example, when the beams are unfolded for analysis, the rotation axis of the first mirror 120A may be oriented in a direction that corresponds to an orthogonal direction relative to the propagation axis of the light pulses 125A, 125B.

Further, in some aspects, the second mirror 120B configured to adjust the elevation emission angle is a plane mirror configured to rotate along an axis (e.g., by an angle θ_{y}) that is orthogonal relative to the propagation axis of the light pulses 125A, 125B. Generally, the angular range of the vertical field of regard is approximately 12-30° (and is usually dynamically adjustable), which corresponds to an angular range of motion for the second mirror 120B of 6-15°. Thus, as an example, the second mirror 120B may rotate by up to 15° along an orthogonal axis relative to the propagation axis of the light pulses 125A, 125B. However, it will be appreciated that the mirrors may be of any suitable geometry, may be arranged in any suitable order, and may rotate by any suitable amount to obtain lidar data corresponding to a suitable field of regard.

As an example of the mirror assembly 120 rotation axes, assume that the propagation axis of the light pulses 125A, 125B is in a z-axis direction. The first mirror 120A may have a rotation axis corresponding to a y-axis direction (for scanning in the θₓ direction), and the second mirror 120B may have a rotation axis corresponding to an x-axis direction (for scanning in the θ_{y} direction). Thus, in this example both the first mirror 120A and the second mirror 120B have scan axes that correspond to orthogonal directions relative to the propagation axis of the light pulses 125A, 125B.

In any event, as the vehicle including the example lidar system 100 travels along a roadway, various obscurants (e.g., water droplets, dirt) may contact the optical window 130, causing the light pulses 125A, 125B emitted by one or more of the light sources 110A, 110B to be obscured during transmission through the optical window 130. Because the emitted light pulses 125A, 125B are scattered, blocked, and/or otherwise obscured by the obscurants, the amount of data received by the receiver 140 is reduced, and information corresponding to the blocked portions of the field of regard is eliminated. However, unlike conventional systems, the spatial displacement of the two light sources 110A, 110B is greater than an average diameter of obscurants (e.g., obscurant 132) that are expected to contact the optical window 130, such that at least one of the two emitted light pulses 125A, 125B will transmit through the optical window 130 without being obscured by the obscurant 132 for each data point within the field of regard. In some aspects, the average diameter of the obscurant 132 contacting the optical window 130 is approximately 1 millimeter. In some aspects, the spatial displacement corresponds to a lateral (or transverse) displacement along an axis orthogonal to the propagation axis of the light pulses 125A, 125B, and the light sources 110A, 110B may also be displaced axially.

Once the light pulses 125A, 125B pass the mirror assembly 120, the light pulses 125A, 125B exit through the optical window 130, reflect/scatter off of an object located in the external environment of the vehicle, and return through the optical window 130 to generate data corresponding to the environment of the vehicle. Depending on the azimuthal/elevation emission angles of the light pulses 125A, 125B, one of the light pulses 125A, 125B may be blocked, scattered, and/or otherwise obscured by the obscurant 132 when exiting through the optical window 130. However, the spatial displacement of the two light pulses 125A, 125B relative to one another is greater than the diameter of the obscurant 132, ensuring that at least one of the light pulses 125A, 125B always returns through the optical window 130 to provide data corresponding to the environment of the vehicle. As a result, the example lidar system 100 is configured to reliably collect environmental data corresponding to the entire field of regard of the lidar system 100 regardless of whether or not an obscurant 132 contacts the optical window 130.

As an example, assume that the first light pulse 125A is obscured by the obscurant 132 at a first azimuthal emission angle and a first elevation emission angle, but the second light pulse 125B is unobscured at these emission angles. The second light pulse 125B may reach a first object located in the external environment of the vehicle and return through the optical window 130 where the second light pulse 125B is again unobscured by the obscurant 132. Continuing this example, assume that the second light pulse 125B is obscured by the obscurant 132 at a second azimuthal emission angle and a second elevation emission angle, but the first light pulse 125A is unobscured at these emission angles. The first light pulse 125A may reach a second object located in the external environment of the vehicle and return through the optical window 130 where the second light pulse 125B is again unobscured by the obscurant 132. Thus, in this example, the example lidar system 100 successfully collects lidar data corresponding to the first object and the second object despite light pulses from both light sources 110A, 110B being obscured by the obscurant at various emission angles. In this manner, and as previously stated, the lidar systems of the present disclosure improve over conventional systems by eliminating/reducing data loss resulting from optical window obscurants (e.g., obscurant 132).

In certain aspects, the first light pulse 125A and the second light pulse 125B have a beam diameter at the optical window 130 of approximately 2 millimeters. The light pulses 125A, 125B are generally collimated light beams with a minor amount of beam divergence (e.g., approximately 0.06-0.12°). Thus, the beam diameter of the light pulses 125A, 125B may increase as the light pulses 125A, 125B propagate towards objects in the environment of the vehicle. For example, the beam diameter of the light pulses 125A, 125B may be approximately 10-20 centimeters at 100 meters from the lidar system 100.

As the light pulses 125A, 125B return through the optical window 130 (as input beams 135), each pulse reflects back through the mirror assembly 120. The input beams 135 may include light from the output beams 125A, 125B that is scattered by the object, light from the output beams 125A, 125B that is reflected by the object, or a combination of scattered and reflected light from object. According to some implementations, the example lidar system 100 can include an “eye-safe” laser that presents little or no possibility of causing damage to a person’s eyes. The input beams 135 may contain only a relatively small fraction of the light from the output beams 125A, 125B.

Further, the output beams 125A, 125B and input beams 135 may be substantially coaxial. In other words, the output beams 125A, 125B and input beams 135 may at least partially overlap or share a common propagation axis, so that the input beams 135 and the output beams 125A, 125B travel along substantially the same optical path (albeit in opposite directions). As the example lidar system 100 scans the output beams 125A, 125B across a field of regard, the input beams 135 may follow along with the output beams 125A, 125B, so that the coaxial relationship between the two beams is maintained.

The light pulses 125A, 125B, returning as input beams 135, eventually reach the receiver 140, which is configured to detect a light pulse and output an electric signal corresponding to the detected light pulse. Generally, the light pulses emitted from the first light source 110A and the second light source 110B are emitted with an angular displacement relative to one another in order to increase the point density of the scanned external vehicle environment. This angular displacement translates to a physical displacement at the focal plane of the receiver 140, thereby rendering a single detector insufficient to accurately detect the location of the light pulses emitted from both the first light source 110A and the second light source 110B. As a result, the receiver 140 may comprise a first detector 140A configured to receive a first portion of the light pulses emitted from the first light source 110A and the second light source 110B, and a second detector 140B configured to receive a second portion of the light pulses emitted from the first light source 110A and the second light source 110B.

The receiver 140 may receive or detect photons from the input beams 135 and generate one or more representative signals. For example, the receiver 140 may generate an output electrical signal that is representative of the input beams 135. The receiver 140 may send the electrical signal to a controller (not shown). Depending on the implementation, the controller may include one or more instruction-executing processors, an application-specific integrated circuit (ASIC), a field-programmable gate array (FPGA), and/or other suitable circuitry configured to analyze one or more characteristics of the electrical signal in order to determine one or more characteristics of the object, such as its distance downrange from the example lidar system 100. More particularly, the controller may analyze the time of flight or phase modulation for the output beams 125A, 125B transmitted by the light sources 110A, 110B. If the example lidar system 100 measures a time of flight of T (e.g., T representing a round-trip time of flight for an emitted pulse of light to travel from the example lidar system 100 to the object and back to the example lidar system 100), then the distance (D) from the object to the example lidar system 100 may be expressed as D=c• T/2, where c is the speed of light (approximately 3.0x10⁸ m/s).

Moreover, in some implementations, the light sources 110A, 110B, the mirror assembly 120, and the receiver 140 may be packaged together within a single housing, which may be a box, case, or enclosure that holds or contains all or part of the example lidar system 100. In some implementations, the housing includes multiple lidar sensors, each including a respective mirror assembly and a receiver. Depending on the particular implementation, each of the multiple sensors can include a separate light source or a common light source. The multiple sensors can be configured to cover non-overlapping adjacent fields of regard or partially overlapping fields of regard, for example, depending on the implementation.

As described above for the example lidar system 100, the two light sources 110A, 110B emit light pulses 125A, 125B that pass through an optical window 130 which may have an obscurant 132 attached or otherwise contacting the window 130 as a result of the vehicle traveling along a roadway. To provide a clearer understanding of how the obscurant 132 causes data loss for conventional systems, and how the techniques of the present disclosure solve such issues, FIGS. 2A-C illustrate obscurants contacting optical windows and the resulting pixel data readouts for conventional systems and the techniques of the present disclosure.

FIG. 2A illustrates example zones of interest 152, 154 projected onto the optical window 130, including an obscurant 132 blocking a portion of a zone of interest, through which the redundant beam scan of the lidar system of FIG. 1 may pass. Generally, the three distinct portions 151, 152, 154 of the optical window 130 illustrated in FIG. 2A correspond to various differences in the type, quantity, and/or other characteristics of the data received through each portion. For example, the outermost region 151 may represent a portion of the optical window 130 that is not used for data acquisition, the first zone of interest 152 may represent an area used for a complete FOR corresponding to, for example, a lidar system (e.g., example lidar system 100), and the second zone of interest 154 may represent a high density region corresponding to data that may, for example, greatly influence decision making and/or control of the vehicle (e.g., representing objects directly in the vehicle’s path).

Accordingly, the first zone of interest 152 may have a first zone height 152A and a first zone width 152B sufficient to define a full FOR for any suitable system (e.g., example lidar system 100), and the second zone of interest 154 may have a second zone height 154A and a second zone width 154B sufficient to define such a high density region for the suitable system. As an example, the second zone height 154A for the optical window 130 within the example lidar system 100 may be approximately 25 millimeters and the second zone width 154B for the optical window 130 within the example lidar system 100 may be approximately 34 millimeters to define a high density region encompassing approximately 35° of azimuth and 10° of elevation.

The obscurant 132 may be any suitable blocking obscurant, such as moisture (e.g., water droplets, ice, snow, etc.), dirt, and/or any other object contacting the optical window 130. As previously mentioned, obscurants contacting an optical window of a lidar system (or any sensor including such a window) included within a vehicle may generally have an average diameter of approximately 1 millimeter. In conventional systems using single output beams, obscurants of such size result in significant data loss because the single output beams are blocked and/or otherwise obscured from returning data to a receiver corresponding to a significant portion of the FOR. For example, FIG. 2B illustrates the data loss effects of the optical window obscurant 132 of FIG. 2A on prior art lidar systems.

As illustrated in FIG. 2B, the prior art lidar output 160 includes the obscurant 132 contacting an optical window 163 through which an output beam 164 is passing along a propagation axis where it eventually reaches a target object 165. As a result of scanning the single output beam 164 across the FOR, the prior art lidar system receives a data output 166 that includes a prominent data shadow 167 representing a region of the FOR for which no data is received due to the presence of the obscurant 132. Thus, in these prior art systems, a single, average-sized obscurant can disrupt data collection, resulting in vehicle components performing decision-making and vehicle control operations based on incomplete data sets.

By contrast, FIG. 2C illustrates the data resiliency of the redundant beam scan of the lidar system 100 of FIG. 1 when encountering the optical window obscurant 132 of FIG. 2A. As illustrated in FIG. 2C, a lidar output 170 utilizing the techniques of the present disclosure includes the obscurant 132 contacting an optical window 173 through which two output beams 174A, 174B are passing along a propagation axis where they eventually reach a target object 175. As a result of scanning the two output beams 174A, 175B across the FOR, each of the output beams 174A, 174B may be blocked and/or otherwise obscured by the obscurant 132 at various angles, but both output beams 174A 174B are never blocked/obscured simultaneously.

Thus, the lidar systems of the present disclosure may receive data outputs similar to data output 176 that includes two partial data shadows 177A, 177B. Each of the partial data shadows 177A, 177B includes data representative of target objects located in those regions of the FOR because the output beam that is not blocked/obscured by the obscurant 132 at those azimuth/elevation angles transmits through the optical window 173, scatters off of the target object 175, and returns through the optical window 173 to the receiver (not shown). For example, at the azimuth/elevation angles represented by the partial data shadow 177A, the second output beam 174B is blocked or otherwise obscured by the obscurant 132, such that the partial data shadow 177A represents a region of the FOR for which no data was received from the second output beam 174B. In this example, the partial data shadow 177A includes data from the first output beam 174A because that beam 174A is not blocked or otherwise obscured by the obscurant 132.

In this manner, the techniques of the present disclosure improve over conventional systems by reliably collecting data representative of an entire FOR of a lidar system, despite the presence of an obscurant on the optical window. Accordingly, the techniques of the present disclosure reduce data loss that plagues conventional techniques, and thereby increases the accuracy and consistency of decision-making and vehicle control operations for autonomous vehicles and autonomous vehicle functionalities.

As described for the example lidar system 100 provided above and illustrated in FIGS. 2B and C, lidar data collected by a vehicle generally includes point cloud data. However, to provide a better understanding of the types of data that may be generated by lidar systems, and of the manner in which lidar systems and devices may function, more example lidar systems and point clouds will now be described with reference to FIGS. 3-5C.

FIG. 3 illustrates an example scan pattern 200 which the example lidar system 100 of FIG. 1 may produce. In particular, the example lidar system 100 may be configured to scan the output beams 125A, 125B along the example scan pattern 200. In some aspects, the scan pattern 200 corresponds to a scan across any suitable field of regard (FOR) having any suitable horizontal field of regard (FOR_{H}) and any suitable vertical field of regard (FOR_{V}). For example, a certain scan pattern may have a field of regard represented by angular dimensions (e.g., FOR_{H} × FORv) 40°×30°, 90°×40°, or 60°×15°. While FIG. 3 depicts a uni-directional (left-to-right) pattern 200, other implementations may instead employ other patterns (e.g., right-to-left, bidirectional (“zig-zag”), horizontal scan lines), and/or other patterns may be employed in specific circumstances.

In FIG. 3, if the example scan pattern 200 has a 60°×15° field of regard, then the example scan pattern 200 covers a ±30° horizontal range and a ±7.5° vertical range with respect to the center of the field of regard. An azimuth (which may be referred to as an azimuth angle) may represent a horizontal angle with respect to the field of regard (e.g., along the FOR_{H}), and an altitude (which may be referred to as an altitude angle, elevation, or elevation angle) may represent a vertical angle with respect to the field of regard (e.g., along the FOR_{V}).

The example scan pattern 200 may include multiple points or pixels 210, and each pixel 210 may be associated with one or more laser pulses and one or more corresponding distance measurements. A cycle of the example scan pattern 200 may include a total of Pₓ×P_{y} pixels 210 (e.g., a two-dimensional distribution of Pₓ by P_{y} pixels). The number of pixels 210 along a horizontal direction may be referred to as a horizontal resolution of the example scan pattern 200, and the number of pixels 210 along a vertical direction may be referred to as a vertical resolution of the example scan pattern 200.

Each pixel 210 may be associated with a distance/depth (e.g., a distance to a portion of an object from which the corresponding laser pulse was scattered) and one or more angular values. As an example, the pixel 210 may be associated with a distance value and two angular values (e.g., an azimuth and altitude) that represent the angular location of the pixel 210 with respect to the example lidar system 100. A distance to a portion of an object may be determined based at least in part on a time-of-flight measurement for a corresponding pulse. More generally, each point or pixel 210 may be associated with one or more parameter values in addition to its two angular values. For example, each point or pixel 210 may be associated with a depth (distance) value, an intensity value as measured from the received light pulse, and/or one or more other parameter values, in addition to the angular values of that point or pixel.

An angular value (e.g., an azimuth or altitude) may correspond to an angle (e.g., relative to the center of the FOR) of the output beams 125A, 125B (e.g., when corresponding pulses are emitted from example lidar system 100) or an angle of the input beam 135 (e.g., when an input signal is received by example lidar system 100). In some implementations, the example lidar system 100 determines an angular value based at least in part on a position of a component of the mirror assembly 120. For example, an azimuth or altitude value associated with the pixel 210 may be determined from an angular position of the first mirror 120A or the second mirror 120B of the mirror assembly 120. The zero elevation, zero azimuth direction corresponding to the center of the FOR may be referred to as a neutral look direction (or neutral direction of regard) of the example lidar system 100. Thus, each of the scan lines 230A-D, 230Aʹ-Dʹ represent a plurality of pixels 210 with different combinations of azimuth and altitude values. For example, half of the pixels 210 included as part of the scan line 230A may include positive azimuth values and altitude values, and the remaining half may include negative azimuth values and positive altitude values. By contrast, each of the pixels 210 included as part of the scan line 230Dʹ may include negative altitude values.

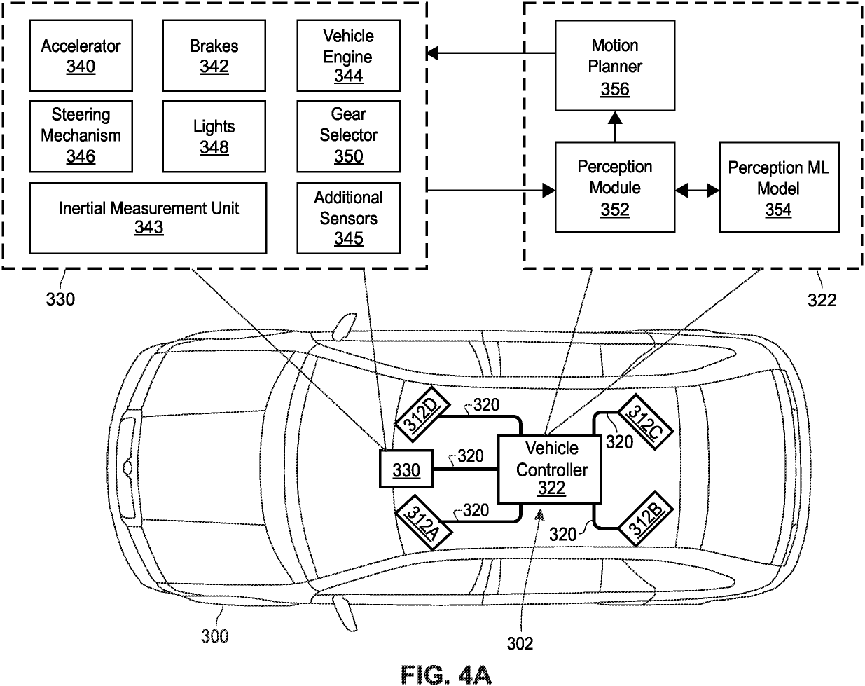

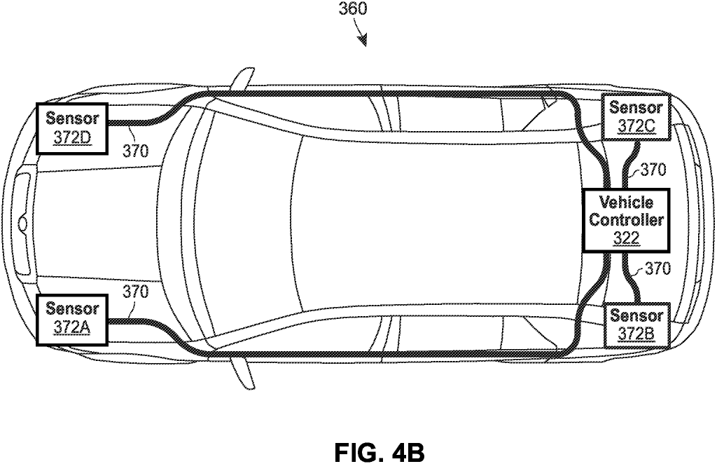

FIG. 4A illustrates an example vehicle 300 with a lidar system 302. The lidar system 302 includes multiple sensor heads 312A-312D, each of which is equipped with a respective laser. Alternatively, the sensor heads 312A-D can be coupled to a single laser via suitable laser-sensor links. In general, each of the sensor heads 312 may include some or all of the components of the example lidar system 100 illustrated in FIG. 1.

The sensor heads 312A-D in FIG. 4A are positioned or oriented to provide a greater than 30-degree view of an environment around the vehicle. More generally, a lidar system with multiple sensor heads may provide a horizontal field of regard around a vehicle of approximately 30°, 45°, 60°, 90°, 120°, 180°, 270°, or 360°. Each of the sensor heads 312A-D may be attached to, or incorporated into, a bumper, fender, grill, side panel, spoiler, roof, headlight assembly, taillight assembly, rear-view mirror assembly, hood, trunk, window, or any other suitable part of the vehicle.

In the example of FIG. 4A, four sensor heads 312A-D are positioned at or near the four corners of the vehicle (e.g., each of the sensor heads 312A-D may be incorporated into a light assembly, side panel, bumper, or fender). The four sensor heads 312A-D may each provide a 90° to 120° horizontal field of regard (FOR), and the four sensor heads 312A-D may be oriented so that together they provide a complete 360-degree view around the vehicle 300. As another example, the lidar system 302 may include six sensor heads 312 positioned on or around the vehicle 300, where each of the sensor heads 312 provides a 60° to 90° horizontal FOR. As another example, the lidar system 302 may include eight sensor heads 312, and each of the sensor heads 312 may provide a 45° to 60° horizontal FOR. As yet another example, the lidar system 302 may include six sensor heads 312, where each of the sensor heads 312 provides a 70° horizontal FOR with an overlap between adjacent FORs of approximately 10°. As another example, the lidar system 302 may include two sensor heads 312 which together provide a forward-facing horizontal FOR of greater than or equal to 30°.

Data from each of the sensor heads 312A-D may be combined or stitched together to generate a point cloud that covers a greater than or equal to 30-degree horizontal view around a vehicle. For example, the laser corresponding to each sensor head 312A-D may include a controller or processor that receives data from each of the sensor heads 312A-D (e.g., via a corresponding electrical link 320) and processes the received data to construct a point cloud covering a 360-degree horizontal view around a vehicle or to determine distances to one or more targets. The point cloud or information from the point cloud may be provided to a vehicle controller 322 via a corresponding electrical, optical, or radio link 320. The vehicle controller 322 may include one or more CPUs, GPUs, and a non-transitory memory with persistent components (e.g., flash memory, an optical disk) and/or non-persistent components (e.g., RAM).

In some implementations, the point cloud is generated by combining data from each of the multiple sensor heads 312A-D at a controller included within the laser(s), and is provided to the vehicle controller 322. In other implementations, each of the sensor heads 312A-D includes a controller or processor that constructs a point cloud for a portion of the 360-degree horizontal view around the vehicle and provides the respective point cloud to the vehicle controller 322. The vehicle controller 322 then combines or stitches together the points clouds from the respective sensor heads 312A-D to construct a combined point cloud covering a 360-degree horizontal view. Still further, the vehicle controller 322 in some implementations communicates with a remote server to process point cloud data.

In any event, the vehicle 300 may be an autonomous vehicle where the vehicle controller 322 provides control signals to various components 330 within the vehicle 300 to maneuver and otherwise control operation of the vehicle 300. The components 330 are depicted in an expanded view in FIG. 4A for ease of illustration only. The components 330 may include an accelerator 340, brakes 342, a vehicle engine 344, a steering mechanism 346, lights 348 such as brake lights, head lights, reverse lights, emergency lights, etc., a gear selector 350, an IMU 343, additional sensors 345 (e.g., cameras, radars, acoustic sensors, atmospheric pressure sensors, moisture sensors, ambient light sensors, as indicated below) and/or other suitable components that effectuate and control movement of the vehicle 300. The gear selector 350 may include the park, reverse, neutral, drive gears, etc. Each of the components 330 may include an interface via which the component receives commands from the vehicle controller 322 such as “increase speed,” “decrease speed,” “turn left 5 degrees,” “activate left turn signal,” etc. and, in some cases, provides feedback to the vehicle controller 322.

The vehicle controller 322 can include a perception module 352 that receives input from the components 330 and uses a perception machine learning (ML) model 354 to provide indications of detected objects, road markings, etc. to a motion planner 356, which generates commands for the components 330 to maneuver the vehicle 300.

In some implementations, the vehicle controller 322 receives point cloud data from the sensor heads 312A-D via the links 320 and analyzes the received point cloud data, using any one or more of the aggregate or individual SDCAs disclosed herein, to sense or identify targets/objects and their respective locations, distances, speeds, shapes, sizes, type of object (e.g., vehicle, human, tree, animal), etc. The vehicle controller 322 then provides control signals via another link 320 to the components 330 to control operation of the vehicle based on the analyzed information.

In addition to the lidar system 302, the vehicle 300 may also be equipped with other sensors 345 such as a camera, a thermal imager, a conventional radar (none illustrated to avoid clutter), etc. The additional sensors 345 can provide additional data to the vehicle controller 322 via wired or wireless communication links. Further, the vehicle 300 in an example implementation includes a microphone array operating as a part of an acoustic source localization system configured to determine sources of sounds.

As another example, FIG. 4B illustrates a vehicle 360 in which several sensor heads 372A-D, each of which may be similar to one of the sensor heads 312A-D of FIG. 4A, are disposed at the front of the hood and on the trunk. In particular, the sensor heads 372B and C are oriented to face backward relative to the orientation of the vehicle 360, and the sensor heads 372A and D are oriented to face forward relative to the orientation of the vehicle 360. In another implementation, additional sensors are disposed at the side view mirrors, for example. Similar to the sensor heads 312A-D of FIG. 4A, these sensor heads 372A-D may also communicate with the vehicle controller 322 (e.g., via a corresponding electrical link 370) to generate the point cloud used to sense or identify targets/objects.

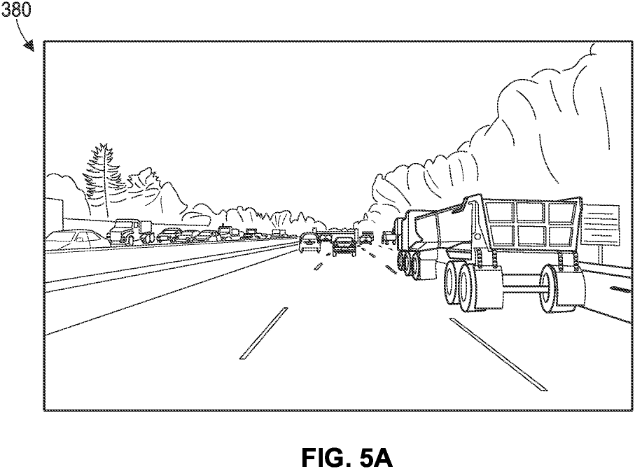

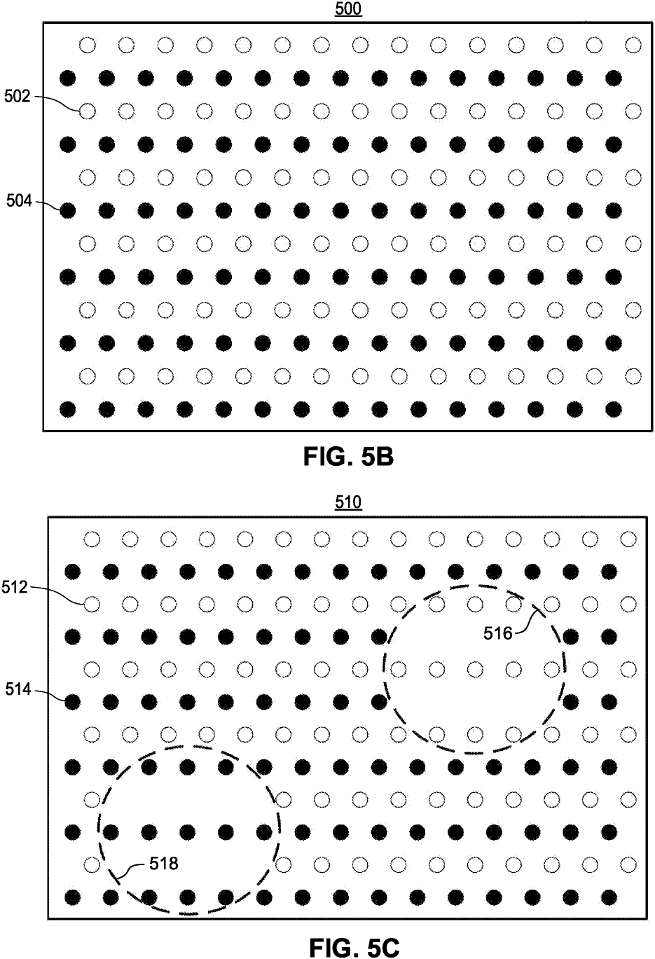

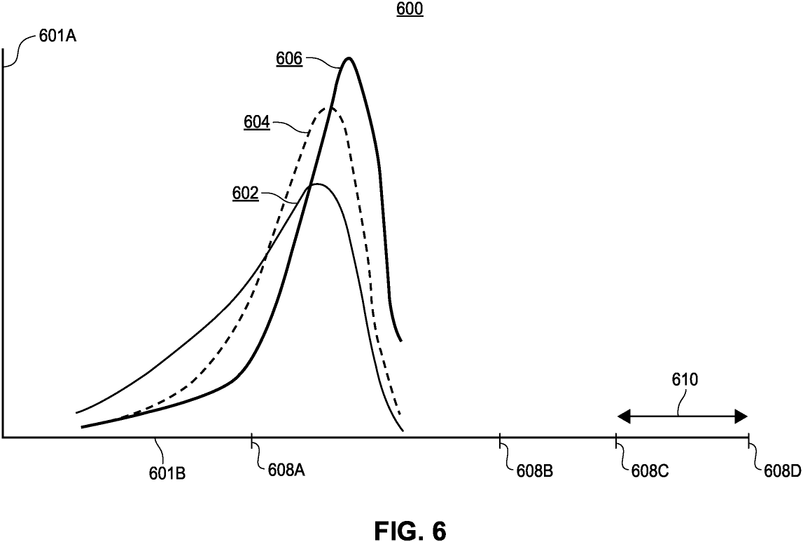

FIG. 5A depicts an example real-world driving environment 380, and FIGS. 5B and 5C depict example pixel readouts 500, 510 over a field of regard that is generated by a lidar system (e.g., example lidar system 100) scanning the environment 380 when the optical window is free of and contacted by obscurants, respectively. As seen in FIG. 5A, the environment 380 includes a highway with a median wall that divides the two directions of traffic, with multiple lanes in each direction. The example pixel readout 500 of FIG. 5B corresponds to an example embodiment in which no obscurant is contacting the optical window of a lidar device (e.g., example lidar system 100), and the lidar device captures a plurality of pixel data wherein each pixel 502, 504 corresponds to an object of the example real-world driving environment 380. In particular, the first pixels 502 correspond to pixel data generated based on input signals received from a first light source (e.g., first light source 110A), and the second pixels 504 correspond to pixel data generated based on input signals received from a second light source (e.g., second light source 110B). As illustrated in FIG. 5B, the example pixel readout 500 includes pixel data corresponding to input signals received from both light sources across all scan lines performed with the light beams emitted by the light sources.

By contrast, FIG. 5C includes an example pixel readout 510 in which an obscurant is contacting the optical window of a lidar device (e.g., example lidar system 100), blocking portions of the first pixels 512 and the second pixels 514, as indicated by the shadow regions 516, 518. Generally, a pixel readout similar to the example pixel readout 510 may result from a single obscurant contacting the optical window because, as the light beams are scanned across the FOR, the obscurant may block and/or otherwise obscure one of the light beams at a time. For example, the obscurant may be positioned in contact with the optical window such that it obscures a first light beam from the first light source at a first azimuth angle and a first elevation angle while a second light beam from the second light source is completely unaffected by the obscurant at those angles. However, at a second azimuth angle and a second elevation angle, the obscurant may obscure the second light beam while the first light beam is completely unaffected by the obscurant. Regardless, it should be understood that the example pixel readout 510 may represent one or more obscurants in contact with the optical window.

The first pixels 512 correspond to pixel data generated based on input signals received from a first light source (e.g., first light source 110A), and the second pixels 514 correspond to pixel data generated based on input signals received from a second light source (e.g., second light source 110B). As illustrated in FIG. 5C, the example pixel readout 510 includes a first shadow region 516 in which the obscurant blocked or otherwise obscured the light pulses from the second light source but was not large enough to obscure the light pulses from the first light source, and a second shadow region 518 in which the obscurant blocked or otherwise obscured the light pulses from the first light source but was not large enough to obscure the light pulses from the second light source. Thus, the spatial displacement of the two light sources enables the lidar system to obtain pixel data corresponding to portions of the FOR that would otherwise be absent due to the obscurant contacting the optical window. As a result, both shadow regions 516, 518 include pixel data, and can therefore inform the AV vehicle perception components to enable safer and more consistent vehicle operation decision making and control.

Moreover, as illustrated in FIG. 5C, the pixel data represented in the shadow regions 516, 518 includes pixel data corresponding to either the first light source or the second light source that may represent pixel data of a similar portion of the image that is lost from either the first light source (e.g., in region 518) or the second light source (e.g., in region 516) as a result of the obscurant. As previously mentioned, the first light source and second light source are spatially displaced from one another such that the output beams are not simultaneously obscured/blocked by an obscurant contacting the optical window. The two light sources are also configured such that the input beams reaching the receiver have a high point density, for example, in the second zone of interest 154 in FIG. 2A. Thus, the two light sources have the advantage of avoiding simultaneous blockage from an obscurant contacting the optical window, and in the event that one light source is obscured/blocked from obtaining data corresponding to a particular region, the other light source will obtain data corresponding to that particular region and generate pixel data that is representative of and/or otherwise similar tothe data the other light source would have obtained.

For example, in the first shadow region 516, the pixel data received from the first light source includes multiple pixels 512 that correspond to substantially similar data the second light source would have obtained within the first shadow region 516 without the presence of the obscurant, as represented by the gaps between the rows of pixels 514 within the first shadow region 516. Without this pixel data from the first light source within the first shadow region 516, the perception components of the vehicle may miss an object within the first shadow region 516 that ought to be considered when determining vehicle control operations. However, because the pixels 512 generated by the light from the first light source are substantially similar to the pixels 514 generated by the light from the second light source, the first light source generates pixel data within the first shadow region 516 that provides sufficient data to determine whether or not such an object exists, features/characteristics of the object, and how best to maneuver the vehicle as a result of the object’s presence. Thus, utilizing two spatially displaced lasers to perform a redundant beam scan in the manners described herein enables a lidar system to analyze an entire FOR regardless of the presence of an obscurant contacting the optical window.

As described above, the size of obscurants contacting the optical window is the primary consideration when determining how to spatially displace the light sources of the example lidar system 100. Accordingly, understanding what size of obscurants vehicles typically encounter, and more particularly, what size of obscurants typically contact and remain affixed to vehicle surfaces for appreciable periods of time is of paramount importance. Thus, sizes and contact periods of typical optical window obscurants will now be described with reference to FIG. 6.

FIG. 6 illustrates a distribution graph 600 of obscurant sizes at several vehicle travel speeds compared to the beam diameter and physical separation of each laser included in the redundant beam scan of the example lidar system 100 of FIG. 1. The distribution graph 600 includes a y-axis 601A that is representative of a percentage population of obscurants featuring a particular obscurant diameter, and an x-axis 601B representative of the obscurant diameter. Each of the plots 602, 604, 606 represent the distribution of obscurant diameters at various travel speeds of a vehicle. Namely, plot 602 may correspond to an obscurant diameter distribution at approximately 40 kilometers per hour (km/h), plot 604 may correspond to an obscurant diameter distribution at approximately 80 km/h, and plot 606 may correspond to an obscurant diameter distribution at approximately 140 km/h.

As illustrated in FIG. 6, the x-axis 601B includes several notable axis demarcations 608A-D, indicating various obscurant diameters. The first axis demarcation 608A may correspond to 0.1 millimeters (mm), the second axis demarcation 608B may correspond to 1 mm, the third axis demarcation 608C may correspond to 2 mm, and the fourth axis demarcation 608D may correspond to 10 mm. Interestingly, each of the plots 602, 604, 606 have a substantial population distribution between 0.1 mm and 1 mm, but no apparent population distribution above 1 mm. In other words, it is unlikely that a vehicle traveling along a roadway will encounter obscurants with a diameter larger than approximately 1 mm.

As previously mentioned, the spatial displacement between the light sources (e.g., light sources 110A, 110B) of the example lidar system 100 are approximately 7 mm, and the beam diameter of the output beams (e.g., output beams 125A, 125B) is approximately 2 mm. Thus, any obscurant contacting the optical window with a diameter equal to or less than 1 mm will not completely block a single output beam, much less obscure/block both output beams simultaneously. To better illustrate this point, the range 610 shown in FIG. 6 represents a range of obscurant diameters which may block one or both output beams of the lidar systems of the present disclosure. An obscurant with a diameter of approximately 2 mm (represented by the third demarcation 608C) may block one output beam, as the obscurant diameter equals the output beam diameter. Further, an obscurant with a diameter of 10 mm (represented by the fourth demarcation 608D) may block both output beams, and practically speaking, an obscurant with a diameter of 9 mm may be sufficient to block both output beams. However, as shown in FIG. 6, it is highly unlikely that a vehicle traveling along a roadway at any typical speed will encounter obscurants of sufficient diameter to block one, much less both output beams.

Nevertheless, it is known that droplet diameters for typical rainfall may range from a minimum of 0.1 mm to approximately 3 mm, and that natural soil on road surfaces may have diameters ranging from 2.5-10 micrometers (µm). Still, it is highly unlikely that any obscurant with a diameter in excess of 1 mm (a “larger” obscurant) will contact and/or remain in contact with the optical window for an extended duration under any driving condition. These larger obscurants are naturally unstable, and as a result, will flow away from the contact point on the vehicle (e.g., an optical window) after a short period (e.g. a few seconds or less). Namely, a stationary vehicle will allow these larger obscurants to coalesce and flow away quickly due to gravity, and a moving vehicle will cause these larger obscurants to coalesce and flow away due to the airflow over the optical window.

In order to perform the redundant beam scanning functionality described above, a lidar system (e.g. example lidar system 100) may be configured according to a method 700, as represented by a flow diagram illustrated in FIG. 7. The method 700 begins by configuring a first light source to emit a first light beam comprising a first light pulse (block 702). The method 700 may also include configuring a second light source to emit a second light beam comprising a second light pulse and having a spatial displacement relative to the first light source (block 704). In certain aspects, the spatial displacement of the second light source relative to the first light source is approximately 7 millimeters. In some aspects, the first light pulse and the second light pulse have a beam diameter at the optical window of approximately 2 mm. Further, in certain aspects, the first light pulse and the second light pulse have approximately identical wavelengths. For example, both light pulses may have a wavelength of approximately 905 nanometers (nm).

Moreover, in some aspects, the first light source has an angular displacement relative to the second light source, and the angular displacement may be in an orthogonal direction relative to the spatial displacement of the first light source from the second light source. For example, if the spatial displacement of the first light source from the second light source is in a perpendicular direction relative to the direction of travel of the vehicle, then the angular displacement of the light sources may be in a parallel direction relative to the direction of travel of the vehicle. The angular displacement enables the lidar system to obtain higher pixel density during the scanning process, because the angular displacement results in receiving pixel data for objects/portions of objects that are slightly offset from one another.

The method 700 also includes configuring a mirror assembly to adjust an azimuth emission angle and an elevation emission angle of the first light pulse and the second light pulse (block 706). Generally, the mirror assembly includes two mirrors that are individually configured to adjust either the azimuth emission angle or the elevation emission angle of the light pulses. However, in certain aspects, the mirror assembly additionally comprises an intermediate mirror configured to reflect the first light pulse and the second light pulse from the azimuth mirror to the elevation mirror.

In some aspects, the mirror assembly may comprise an azimuth mirror configured to adjust the azimuth emission angle of the first light pulse and the second light pulse. In these aspects, the azimuth mirror may be a polygonal mirror and may be configured to adjust the azimuth emission angle of the first light pulse and the second light pulse first light pulse and the second light pulse by rotating at least 35 degrees along an axis that is orthogonal to a propagation axis of the first light pulse and the second light pulse.

Further, in certain aspects, the mirror assembly may comprise an elevation mirror configured to adjust the elevation emission angle of the first light pulse and the second light pulse first light pulse and the second light pulse. The elevation mirror may be configured to adjust the elevation emission angle of the first light pulse and the second light pulse first light pulse and the second light pulse by rotating up to 15 degrees along an axis that is orthogonal to a propagation axis of the first light pulse and the second light pulse.

The method 700 may also include configuring an optical window to transmit the first light pulse and the second light pulse (block 708), and determining an average diameter of an obscurant expected to contact the optical window (block 710). In certain aspects, the average diameter of the obscurant expected to contact the optical window is approximately 1 mm.

The method 700 may also include spatially displacing the second light source relative to the first light source so that the spatial displacement is greater than the average diameter of the obscurant (block 712). Further, in certain aspects, the spatial displacement of the second light source relative to the first light source is such that the first light pulse and the second light pulse produce two pixels corresponding to a same portion of an image, wherein the two pixels are used to render the same portion of the image. Upon transmission through the optical window, the light beams may diffuse such that once they reach a target object and return to the receiver, the pixels generated as a result may be adjacent to one another and/or within several pixels of one another. Thus, the spatial displacement (and, in certain aspects, the angular displacement) of the second light source relative to the first light source may generate similar and/or identical pixel data despite the light sources being spatially displaced at a distance greater than the average diameter of an obscurant expected to contact the optical window. Moreover, in these aspects, the two or more detectors may be configured to output the electric signal(s) for generating the two pixels.

The method 700 may also include configuring a receiver to receive the first light pulse and the second light pulse that are scattered by one or more targets (block 714). The receiver may include two or more detectors, and each detector may be configured to detect the first light pulse or the second light pulse and output an electric signal. In other words, each detector may be paired with a respective light source, such that each detector will only receive scattered light from the corresponding respective light source. For example, a first detector (e.g., first detector 140A) may be paired with a first light source (e.g., first light source 110A) and a second detector (e.g., second detector 140B) may be paired with a second light source (e.g., second light source 110B). In this example, the first detector may only detect light emitted by the first light source, and the second detector may only detect light emitted by the second light source, such that light emitted from the first light source being detected by the second detector (e.g., crosstalk) is minimized/eliminated to reduce false/spurious detections.

Thus, in certain aspects, the two or more detectors may comprise a first detector configured to receive a first portion of the first light pulse, and a second detector configured to receive a second portion of the second light pulse. Of course, it should be understood that the receiver may include four or more detectors, such that two (or more) detectors are configured to receive the first portion of the first light pulse and two (or more) detectors are configured to receive the second portion of the second light pulse.

Additionally, in certain aspects, the detectors may be configured to detect the first light beam or the second light beam and output an electric signal for generating a first set of pixel data corresponding to the first light beam and a second set of pixel data corresponding to the second light beam. In these aspects, the first set of pixel data may include a first gap and the second set of pixel data may include a second gap that does not completely overlap the first gap. As a result of the spatial displacement of the light sources, a single obscurant may block a portion of the pixel data obtained by the first light source and a different portion of the pixel data obtained by the second light source (e.g., as illustrated in FIG. 5C), such that the composite/combined pixel data from both the first light source and the second light source represents the entire field of regard. Of course, in certain cases, an obscurant may be sufficiently large to block the same portions of both light sources, but as previously discussed, the average obscurant will only block a portion of one light source at any particular azimuth/elevation angle.

What is claimed is:

1. A scanning lidar system for performing a redundant beam scan to reduce data loss resulting from obscurants, the system comprising:
a first light source configured to emit a first light beam comprising a first light pulse;
a second light source configured to emit a second light beam comprising a second light pulse and having a spatial displacement relative to the first light source;
a mirror assembly configured to adjust an azimuth emission angle and an elevation emission angle of the first light pulse and the second light pulse;
an optical window configured to transmit the first light pulse and the second light pulse, wherein the spatial displacement of the second light source relative to the first light source is such that the first light pulse and the second light pulse produce two pixels corresponding to a same portion of an image, wherein the two pixels are used to render the same portion of the image; and
a receiver configured to receive the first light pulse and the second light pulse that are scattered by one or more targets, the receiver including two or more detectors, wherein each detector is configured to detect the first light pulse or the second light pulse and output an electric signal for generating the two pixels.

2. The scanning lidar system of claim 1, wherein the spatial displacement of the second light source relative to the first light source is approximately 7 millimeters, such that the displacement is greater than an average diameter of an obscurant expected to contact the optical window.

3. The scanning lidar system of claim 1, wherein the mirror assembly comprises an azimuth mirror configured to adjust the azimuth emission angle of the first light pulse and the second light pulse.

4. The scanning lidar system of claim 3, wherein the azimuth mirror is configured to adjust the azimuth emission angle of the first light pulse and the second light pulse by rotating at least 35 degrees along an axis that is orthogonal to a propagation axis of the first light pulse and the second light pulse.

5. The scanning lidar system of claim 3, wherein the azimuth mirror comprises a polygonal mirror.

6. The scanning lidar system of claim 3, wherein the mirror assembly comprises an elevation mirror configured to adjust the elevation emission angle of the first light pulse and the second light pulse.

7. The scanning lidar system of claim 6, wherein the elevation mirror is configured to adjust the elevation emission angle of the first light pulse and the second light pulse by rotating up to 15 degrees along an axis that is orthogonal to a propagation axis of the first light pulse and the second light pulse.

8. The scanning lidar system of claim 6, wherein the mirror assembly comprises an intermediate mirror configured to reflect the first light pulse and the second light pulse from the azimuth mirror to the elevation mirror.

9. The scanning lidar system of claim 1, wherein the two or more detectors comprises a first detector configured to receive a first portion of the first light pulse, and a second detector configured to receive a second portion of the second light pulse.

10. The scanning lidar system of claim 1, wherein the first light source has an angular displacement relative to the second light source.

11. The scanning lidar system of claim 10, wherein the angular displacement is in an orthogonal direction relative to the spatial displacement of the first light source from the second light source.

12. The scanning lidar system of claim 1, wherein the first light pulse and the second light pulse have a beam diameter at the optical window of approximately 2 millimeters.

13. The scanning lidar system of claim 1, wherein the first light pulse and the second light pulse have approximately identical wavelengths.

14. The scanning lidar system of claim 1, wherein the average diameter of the obscurant expected to contact the optical window is approximately 1 millimeter.

15. A method of configuring a scanning lidar system for performing a redundant beam scan to reduce data loss resulting from obscurants, the method comprising:
configuring a first light source to emit a first light beam comprising a first light pulse;
configuring a second light source to emit a second light beam comprising a second light pulse and having a spatial displacement relative to the first light source;
configuring a mirror assembly to adjust an azimuth emission angle and an elevation emission angle of the first light pulse and the second light pulse;
configuring an optical window to transmit the first light pulse and the second light pulse;
determining an average diameter of an obscurant expected to contact the optical window;
spatially displacing the second light source relative to the first light source so that the spatial displacement is greater than the average diameter of the obscurant;
configuring a receiver to receive the first light pulse and the second light pulse that are scattered by one or more targets, the receiver including two or more detectors, wherein each detector is configured to detect the first light pulse or the second light pulse and output an electric signal.

16. The method of claim 15, wherein the spatial displacement of the second light source relative to the first light source is approximately 7 millimeters.

17. The method of claim 15, wherein the mirror assembly comprises an azimuth mirror configured to adjust the azimuth emission angle of the first light pulse and the second light pulse.

18. The method of claim 17, wherein the azimuth mirror is configured to adjust the azimuth emission angle of the first light pulse and the second light pulse first light pulse and the second light pulse by rotating at least 35 degrees along an axis that is orthogonal to a propagation axis of the first light pulse and the second light pulse.

19. The method of claim 17, wherein the azimuth mirror comprises a polygonal mirror.

20. The method of claim 17, wherein the mirror assembly comprises an elevation mirror configured to adjust the elevation emission angle of the first light pulse and the second light pulse first light pulse and the second light pulse.

21. The method of claim 20, wherein the elevation mirror is configured to adjust the elevation emission angle of the first light pulse and the second light pulse first light pulse and the second light pulse by rotating up to 15 degrees along an axis that is orthogonal to a propagation axis of the first light pulse and the second light pulse.

22. The method of claim 20, wherein the mirror assembly comprises an intermediate mirror configured to reflect the first light pulse and the second light pulse from the azimuth mirror to the elevation mirror.

23. The method of claim 15, wherein the two or more detectors comprise a first detector configured to receive a first portion of the first light pulse, and a second detector configured to receive a second portion of the second light pulse.

24. The method of claim 15, wherein the first light source has an angular displacement relative to the second light source.

25. The method of claim 24, wherein the angular displacement is in an orthogonal direction relative to the spatial displacement of the first light source from the second light source.

26. The method of claim 15, wherein the first light pulse and the second light pulse have a beam diameter at the optical window of approximately 2 millimeters.

27. The method of claim 15, wherein the first light pulse and the second light pulse have approximately identical wavelengths.

28. The method of claim 15, wherein the average diameter of the obscurant expected to contact the optical window is approximately 1 millimeter.

29. The method of claim 15, wherein the spatial displacement of the second light source relative to the first light source is such that the first light pulse and the second light pulse produce two pixels corresponding to a same portion of an image, wherein the two pixels are used to render the same portion of the image.

30. The method of claim 29, wherein the two or more detectors are configured to output the electric signal for generating the two pixels.

31. A method of configuring a scanning lidar system for performing a redundant beam scan to reduce data loss resulting from obscurants, the method comprising:
determining a spatial displacement of a first light source relative to a second light source such that a first light pulse emitted from the first light source and a second light pulse emitted from the second light source produce two pixels corresponding to a same portion of an image, wherein the two pixels are used to render the same portion of the image;
spatially displacing the first light source relative to the second light source at the spatial displacement;
configuring a mirror assembly to adjust an azimuth emission angle and an elevation emission angle of the first light pulse and the second light pulse;
configuring the optical window to transmit the first light pulse and the second light pulse; and
configuring a receiver to receive the first light pulse and the second light pulse that are scattered by one or more targets, the receiver including two or more detectors configured to detect the first light pulse or the second light pulse and output an electric signal for generating the two pixels.

32. A scanning lidar system for performing a redundant beam scan to reduce data loss resulting from obscurants, the system comprising:
a first light source configured to emit a first light beam;
a second light source configured to emit a second light beam and having a spatial displacement relative to the first light source;
a mirror assembly configured to adjust an azimuth emission angle and an elevation emission angle of the first light beam and the second light beam in a scanning pattern across a field of regard;
an optical window configured to transmit the first light beam and the second light beam; and;
a receiver configured to receive the first light beam and the second light beam that are scattered by one or more targets, the receiver including two or more detectors, wherein each detector is configured to detect the first light beam or the second light beam and output an electric signal for generating a first set of pixel data corresponding to the first light beam and a second set of pixel data corresponding to the second light beam, wherein the first set of pixel data includes a first gap and the second set of pixel data includes a second gap that does not completely overlap the first gap.
